(19) United States
(12) Patent Application Publication
(10) Pub. No.: US 2024/0204294 A1
(43) Pub. Date: Jun. 20, 2024

(54) BATTERY DEVICE

(71) Applicant: SK ON CO., LTD., Seoul (KR)

(72) Inventors: Suk Ho SHIN, Daejeon (KR); Min Song KANG, Daejeon (KR); Ji Woong KIM, Daejeon (KR); Byeong Jun PAK, Daejeon (KR); Ju Yong PARK, Daejeon (KR); Jin Su HAN, Daejeon (KR)

(21) Appl. No.: 18/536,922

(22) Filed: Dec. 12, 2023

(30) Foreign Application Priority Data
Dec. 15, 2022 (KR) 10-2022-0175869

(51) Int. Cl. H01M 10/6557; H01M 10/613; H01M 10/647; H01M 50/209; H01M 50/211; H01M 50/291; H01M 50/507; H01M 50/51

(52) U.S. Cl. CPC H01M 10/6557; H01M 10/613; H01M 10/647; H01M 50/209; H01M 50/211; H01M 50/291; H01M 50/507; H01M 50/51

(57) ABSTRACT

A battery device is disclosed. In some implementations, the battery device includes a housing that includes an accommodation space, a plurality of battery cells, a plurality of cooling plates, each cooling plate disposed between adjacent battery cells of the plurality of battery cells and including a cooling flow path, a cooling pipe connected to the cooling plate, and a busbar electrically connected to the plurality of battery cells, wherein each of the plurality of battery cells and each of the plurality of cooling plates extend in a first direction and are stacked in a second direction, crossing the first direction, the cooling pipe is coupled to the cooling plate in a third direction, crossing the first and second directions, and each of the plurality of battery cells includes an electrode terminal disposed to face toward the busbar in the third direction to be in contact with the busbar.

### CROSS-REFERENCE TO RELATED APPLICATIONS

This patent document claims the priority and benefits of Korean Patent Application No. 10-2022-0175869 filed on Dec. 15, 2022, the disclosure of which is incorporated herein by reference in its entirety.

### TECHNICAL FIELD

The technology and implementations disclosed in this patent document generally relate to a battery device that includes a plurality of battery cells, and, more particularly, to a battery device including a plurality of battery cells and a cooling structure for cooling the battery cells.

### BACKGROUND

Unlike primary batteries, secondary batteries may be charged and discharged. Because of this aspect, secondary batteries are widely used in battery-powered devices or systems, such as digital cameras, mobile phones, laptop computers, hybrid vehicles, and electric vehicles.

### SUMMARY

The disclosed technology may be implemented in some example embodiments to provide a battery device having improved assembly and workability for connecting a cooling plate to a flow path.

The disclosed technology may also be implemented in some example embodiments to provide a battery device having a simple structure for connecting a cooling plate to a flow path.

The disclosed technology may also be implemented in some example embodiments to provide a battery device in which electrode terminals of battery cells are easily electrically connected.

The disclosed technology may also be implemented in some example embodiments to provide a battery device having improved cooling efficiency.

In some example embodiments of the disclosed technology, a battery device may include: a housing structured to provide an accommodation space; a plurality of battery cells accommodated in the accommodation space; a plurality of cooling plates, each cooling plate disposed between adjacent battery cells of the plurality of battery cells and including a cooling flow path to transfer heat out of the adjacent battery cells; a cooling pipe connected to the cooling plate to allow a refrigerant to flow through the cooling flow path; and a busbar electrically connected to the plurality of battery cells and disposed to be adjacent to a bottom plate of the housing in the accommodation space, wherein the plurality of battery cells and the plurality of cooling plates extend in a first direction and are stacked in a second direction, crossing the first direction, the cooling pipe is coupled to the cooling plate in a third direction, crossing the first and second directions, and the plurality of battery cells includes an electrode terminal disposed to face toward the busbar in the third direction to be in contact with the busbar.

In some implementations, at least one of the plurality of cooling plates may extend in the third direction to be coupled to the cooling pipe.

In some implementations, the cooling plate may include a first connector extending in the third direction, the cooling pipe includes a second connector in contact with a main pipe and extending in a direction that is opposite to the first connector, and the first connector is configured to be coupled to the second connector.

In some implementations, the cooling plate may further include a main body facing the battery cell, the cooling flow path being formed in the main body, and the first connector is installed at both ends of the main body.

In some implementations, the cooling plate may have a length longer than a length of the battery cell, wherein the first connector is configured to be exposed to an outside of the battery cell at both ends of the main body.

In some implementations, the first connector may have a shape extending from both ends of the main body in the third direction.

In some implementations, the housing may include a support opening into which the first connector is inserted and supported.

In some implementations, the support opening may have a shape extending in the third direction structured to prevent the first connector from being separated from the support opening in a direction that is perpendicular to the third direction.

In some implementations, the cooling pipe may be disposed in a lower portion of the support opening in the accommodation space.

In some implementations, the first connector may include a portion that extends in the second direction and another portion that is bent in the third direction.

In some implementations, the battery device may further include an insulating plate including an insulating material and disposed between the plurality of battery cells and the busbar, wherein the insulating plate includes a through-hole through which the electrode terminal passes.

In some implementations, the battery device may further include a support plate structured to support the plurality of battery cells and disposed between the insulating plate and the plurality of battery cells, wherein the support plate includes a through-hole through which the electrode terminal passes.

In some implementations, the battery device may further include an additional plate including an insulating material and disposed between the busbar and the bottom plate.

In some implementations, the cooling pipe may include an inlet flow path structured to supply the refrigerant to the cooling plate and an outlet flow path through which the refrigerant discharged from the cooling plate flows, and the inlet flow path and the outlet flow path may be disposed to be adjacent to a corner or an edge between a sidewall and the bottom plate of the. In some implementations, the cooling pipe may further include a connection flow path disposed to be adjacent to the corner between the sidewall and the bottom plate of the housing to connect the inlet flow path to the outlet flow path.

In some implementations, the battery cell may include a plurality of cells arranged in the first direction, and each cell includes a prismatic secondary battery or a pouch-type secondary battery. In some implementations, the battery cell may have a structure in which the plurality of cells are connected in series.

In some example embodiments of the disclosed technology, a battery device may include: a housing including an accommodation space; a cell assembly including a plurality of battery cells accommodated in the accommodation space and a plurality of cooling plates, each cooling plate disposed between adjacent battery cells of the plurality of battery cells and including a cooling flow path; a cooling pipe connected to the cooling plate to allow a refrigerant to flow through the cooling flow path; and a busbar electrically connected to the plurality of battery cells and disposed to be adjacent to a bottom plate of the housing in the accommodation space, wherein the cell assembly is accommodated in the accommodation space in a third direction in a state in which the cooling pipe and the busbar are disposed inside the accommodation space, the plurality of battery cells includes electrode terminals disposed to face toward the busbar in the third direction to be in contact with the busbar, and the plurality of cooling plates and the cooling pipe are coupled to each other, and the electrode terminals of the plurality of battery cells are electrically connected to the busbar.

### BRIEF DESCRIPTION OF DRAWINGS

Certain aspects, features, and advantages of the disclosed technology are illustrated by the following detailed description with reference to the accompanying drawings.

FIG. 1 is an exploded perspective view of a battery device based on an example embodiment.

FIG. 2 is a perspective view illustrating a state in which a cooling plate and a battery cell illustrated in FIG. 1 are installed.

FIG. 3 is a perspective view illustrating a state in which the cooling plate and a cooling pipe illustrated in FIG. 1 are coupled.

FIG. 4 is an exploded perspective view illustrating a state in which the cooling plate and the cooling pipe illustrated in FIG. 3 are separated.

FIG. 5 is an enlarged exploded perspective view of the cooling plate and the cooling pipe illustrated in FIG. 4.

FIG. 6 is a perspective view illustrating a modified example of a cooling plate.

FIG. 7 is a view illustrating a flow of refrigerant in the battery device illustrated in FIG. 1.

FIG. 8 is an exploded perspective view of a battery device based on another example embodiment.

FIG. 9 is a perspective view illustrating a state in which a cooling plate and a battery cell illustrated in FIG. 8 are installed.

FIG. 10 is an enlarged perspective view of a corner of a first housing illustrated in FIG. 8.

FIG. 11 is an exploded perspective view of some components of the battery device illustrated in FIG. 8 viewed in a lower direction.

FIG. 12 is a cross-sectional view taken in line I-I′ of FIG. 10.

FIG. 13 is an exploded perspective view of a battery device based on another example embodiment.

FIG. 14 is a perspective view illustrating a state in which a cooling plate and a cooling pipe illustrated in FIG. 13 are coupled.

FIG. 15 is an exploded perspective view illustrating a state in which the cooling plate and the cooling pipe illustrated in FIG. 13 are separated.

### DETAILED DESCRIPTION

Secondary batteries are widely used in battery-powered devices or systems. Examples of secondary batteries include nickel-cadmium batteries, nickel-metal hydride batteries, nickel-hydrogen batteries, lithium secondary batteries, and others.

Secondary batteries may include flexible pouch-type battery cells, rigid prismatic battery cells, or rigid cylindrical battery cells that are electrically connected. A plurality of battery cells may form a stacked cell assembly.

In some implementations, a cell assembly is disposed inside a module housing to form a battery module, and a plurality of battery modules may be disposed inside a pack housing to form a battery pack. In some implementations, in order to increase the energy density of battery packs, a cell assembly may also be directly installed inside pack housings.

Since battery cells generate a large amount of heat during charging and discharging, battery devices (including a battery module and a battery pack) may include a cooling member for cooling battery cells.

In some implementations, a cooling plate is installed between battery cells. In this case, since the cooling plate is in contact with a large surface of the battery cells, a contact area may increase, thereby increasing the cooling efficiency of the battery cells.

Such as cooling plate may have a structure in which the cooling plate is assembled in a vertical direction of the battery device and a flow path is connected to the cooling plate in a horizontal direction. Therefore, since the assembly direction of the cooling plate is different from the flow path connection direction of the cooling plate, assembly difficulty may increase.

example In some embodiments of the disclosed technology, a battery device 100 may include a plurality of battery assemblies including a plurality of battery cells 130 installed inside a housing 110. In some embodiments of the disclosed technology, the term “battery device” (e.g., 100) may be used to indicate a battery module in which a battery assembly is installed, and a battery pack in which a battery assembly is directly installed in the housing 110 without a module.

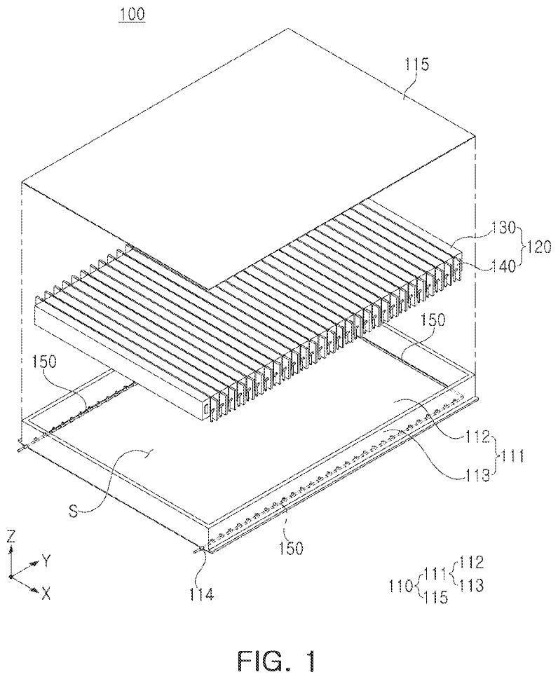

In some embodiments of the disclosed technology, the battery device 100 may have structural features as will be discussed below with reference to FIGS. 1 to 7.

FIG. 1 is an exploded perspective view of the battery device 100 based on an example embodiment.

Referring to FIG. 1, the battery device 100 based on an example embodiment may include a housing 110, a plurality of battery cells 130, a plurality of cooling plates 140, and a cooling pipe 150.

An accommodation space S is formed inside the housing 110. The housing 110 may include a first housing 111 and a second housing 115. The first housing 111 may have a shape in which the accommodation space S is formed, and the second housing 115 may have a structure covering the accommodation space S. The plurality of battery cells 130, the plurality of cooling plates 140, and the cooling pipe 150 may be accommodated in the accommodation space S formed in the housing 110. The plurality of battery cells 130 and the plurality of cooling plates 140 may each have a shape extending in a first direction X and may be stacked in a second direction Y intersecting the first direction X. The plurality of battery cells 130 and the plurality of cooling plates 140 may be accommodated in the accommodation space S in a third direction Z (e.g., −Z axis direction) in a state in which the cooling pipe 150 is disposed inside the accommodation space S.

The first housing 111 may include a bottom plate 112 and a sidewall 113. In one implementation, the bottom plate 112 and the sidewall 113 may be formed separately and then coupled by a coupling method, such as welding or bolting. In another implementation, the bottom plate 112 and the sidewall 113 may be integrally formed. In some implementations, the sidewall 113 may be integrally formed. In some implementations, a plurality of parts of the first housing 111 may be separately formed and then coupled to each other.

However, as long as the accommodation space S is formed in the housing 110, the housing 110 is not limited to the aforementioned structure and may be variously modified. For example, the sidewall 113 may be provided in both the first housing 111 and the second housing 115.

The plurality of battery cells 130 may be accommodated in the accommodation space S. The plurality of battery cells 130 may be disposed in the accommodation space S in a state of being erected in the third direction Z.

The battery cell 130 may include a secondary battery. The battery cell 130 may include a lithium secondary battery, a nickel-cadmium battery, a nickel-metal hydride battery, a nickel-hydrogen battery, and others. The battery cell 130 may include a flexible pouch-type secondary battery or a prismatic secondary battery. In addition, the battery cell 130 may have a shape extending in the first direction X.

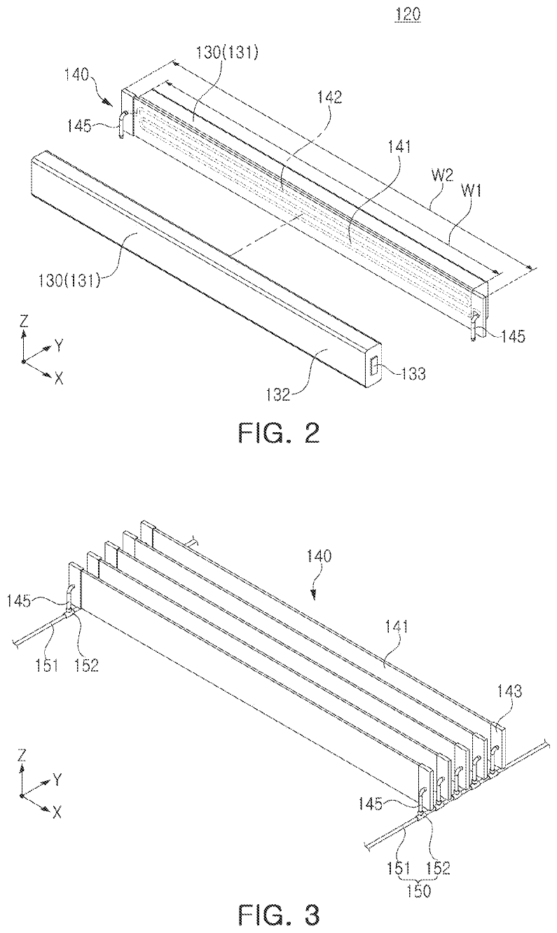

The plurality of battery cells 130 may be stacked in the second direction Y, and the cooling plate 140 may be disposed between at least some of the battery cells 130. The cooling plate 140 may include a cooling flow path (142 in FIG. 2) in which a refrigerant flows to transfer heat out of the battery cells 130. In some embodiments, the term “refrigerant” (or cooling medium) can be used to indicate a fluid that can be used for cooling and includes gas as well as liquid, such as cooling water.

The plurality of cooling plates 140 may be disposed in the accommodation space S in a state of being erected in the third direction Z. The cooling plate 140 may be disposed between at least some of the battery cells 130 among the plurality of battery cells 130. The battery cells 130 may be disposed on both sides of the cooling plate 140, respectively. The cooling plate 140 and the battery cells 130 may be alternately stacked. In some implementations, the cooling plate 140 may be disposed between some of the battery cells 130. For example, two or more battery cells 130 may be disposed between adjacent cooling plates 140.

The plurality of battery cells 130 and the plurality of cooling plates 140 may be stacked in the second direction Y to form the cell assembly 120. To form the cell assembly 120, the plurality of battery cells 130 and the plurality of cooling plates 140 may be fixed to each other. For example, at least some of the battery cells 130 and the cooling plates 140 may be fixed to each other by double-sided tape, thermally conductive adhesive, or others. However, the fixing method of the battery cell 130 and the cooling plate 140 is not limited thereto. For example, in a state in which the battery cells 130 and the cooling plates 140 are stacked, at least a portion of an outer circumferential surface of the stack may be surrounded by a strap or tape. In some implementations, the battery cells 130 and the cooling plate 140 may not be fixed to each other so that each battery cell 130 is disposed in the accommodation space S or each cooling plate 140 is disposed in the accommodation space S.

The cooling pipe 150 may be connected to the cooling plate 140 so that a refrigerant flows therein. The cooling pipe 150 may be a passage for supplying a refrigerant to the cooling flow path (e.g., 142 of FIG. 2) of the cooling plate 140 or allowing a refrigerant discharged from the cooling flow path (e.g., 142 of FIG. 2) to flow therethrough, thus carrying away the heat from the battery cells 130.

The cooling pipe 150 may be disposed in the housing 110 so as to be located in a lower portion of the accommodation space S of the housing 110. In order to reduce space occupied by the cooling pipe 150, the cooling pipe 150 may be disposed to be adjacent to a corner (or an edge) at which the bottom plate 112 and the sidewall 113 meet. The cooling pipe 150 may be disposed along the corner at which the bottom plate 112 and the sidewall 113 meet. An opening 114 for a pipe may be implemented or formed in the housing 110 so that the cooling pipe 150 may be exposed to the outside of the housing 110 to release heat that is carried by the refrigerant flow. The opening 114 for a pipe may include a hole or recess formed in the sidewall 113 of the housing 110, but a tubular structure extending in a longitudinal direction of the cooling pipe 150 may be additionally disposed. In order to simplify a supply and recovery structure of the refrigerant, the opening 114 for a pipe may be disposed on one side of the housing 110.

FIG. 2 is a perspective view illustrating a state in which the cooling plate 140 and the battery cell 130 illustrated in FIG. 1 are installed.

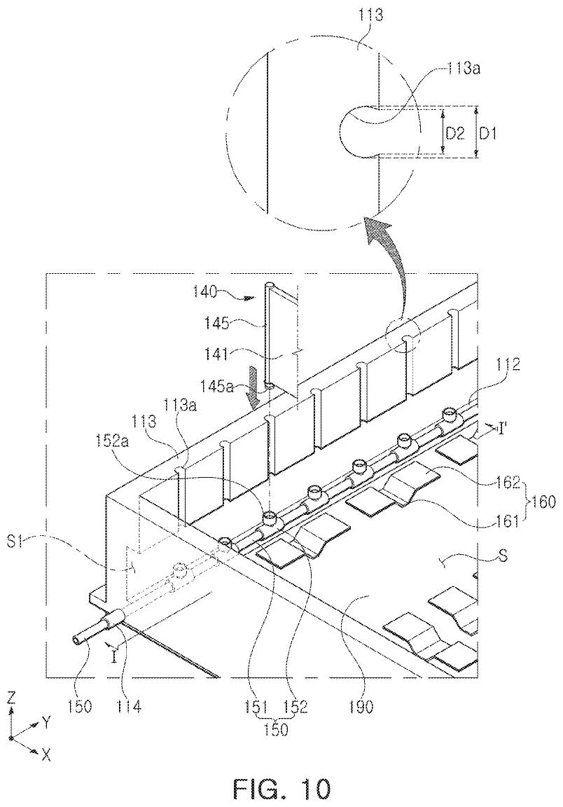

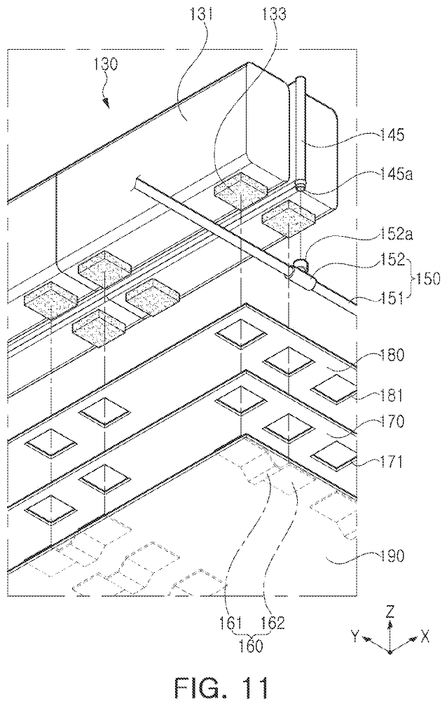

Referring to FIG. 2, each battery cell 130 may be configured as a secondary battery in which an electrode assembly (not shown) is accommodated in a casing 132. Each battery cell 130 may include a plurality of electrode terminals 133. The electrode terminal 133 may be electrically connected to an electrode assembly accommodated inside the casing 132. In the battery cell 130, electrode terminals 133 may be formed at both ends of the casing 132. However, the arrangement structure of the electrode terminals 133 is not limited thereto, and as illustrated in FIGS. 10 and 11, the electrode terminals 133 may be disposed on a lower surface in the third direction Z. The electrode terminal 133 provided in each battery cell 130 may be electrically connected to the electrode terminal 133 of an adjacent battery cell 130 by a busbar (not shown). The busbar may be electrically connected to the electrode terminal 133 of the battery cell 130 to implement a serial and/or parallel electrical connection between the battery cells 130. The battery cell 130 may include a prismatic secondary battery, but the disclosed technology is not limited thereto. In some implementations, the battery cell 130 may include a pouch-type secondary battery.

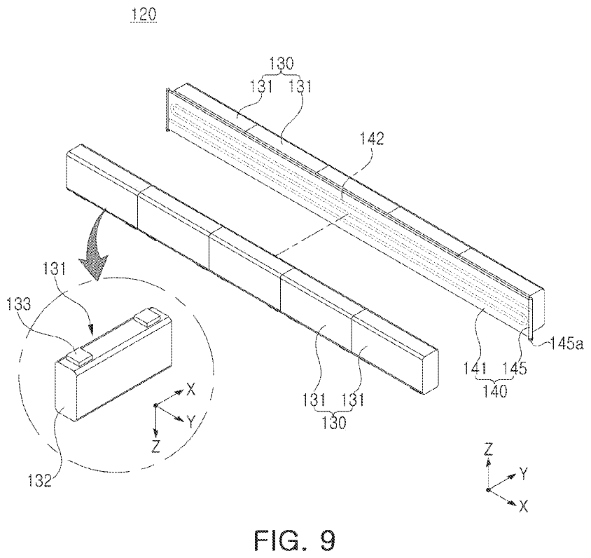

The battery cell 130 may include a single cell 131 having a predetermined length (a width in the long direction) W1 in the first direction X, but the disclosed technology is not limited thereto. For example, the battery cell 130 may include a plurality of cells 131 arranged in the first direction X (refer to FIG. 9).

The battery cell 130 may be connected to the cooling plate 140 to dissipate heat generated in the battery cell 130. The battery cells 130 may be disposed on both sides of the cooling plate 140, respectively. When the cooling plates 140 and the battery cells 130 are alternately stacked, the cooling plates 140 may be disposed on both sides of the battery cells 130, respectively. Accordingly, since heat generated in the battery cell 130 is discharged to the cooling plate 140 through both sides of the battery cell 130, cooling efficiency of the battery cell 130 may be increased.

A cooling flow path 142 may be formed inside the cooling plate 140 to allow a refrigerant to flow. The cooling plate 140 may include a main body 141 that faces the battery cell 130, and the cooling flow path 142 may pass through the main body 141. The main body 141 may have an area that may sufficiently contact a large surface (e.g., a surface on an X-Z plane) of the battery cell 130. For example, the main body 141 may have a larger area than a large surface (e.g., a surface on the X-Z plane) of the casing 132.

The cooling plate 140 may include a first connector 145 to supply a refrigerant to the cooling flow path 142 that cools the battery cells 130 and absorbs the heat generated by the battery cells 130 in the refrigerant flow and discharge the refrigerant from the cooling flow path 142, thus carrying away the heat generated by the battery cells 130 and lowering the temperature of the battery cells 130. The refrigerant introduced through the first connector 145 on one side, which is at a lower temperature, may flow through the cooling flow path 142 and thus absorbs heat from the battery cells 130, and then the refrigerant be discharged through the first connector 145 on the other side to carry away the heat from the battery cells 130. As illustrated in FIG. 2, the cooling flow path 142 may be a zigzag-shaped flow path to increase the path length of the cooling flow path 142 that interfaces with the battery cells 130 and thus the cooling effect, but is not limited thereto. For example, in some other implementations, the cooling flow path 142 may also be formed of a single flow path space disposed between the first connector 145 on one side and the first connector 145 on the other side.

The first connectors 145 may be respectively installed at both ends of the main body 141. In the cooling plate 140, the first connector 145 may be exposed to the outside of the battery cell 130 at both ends of the main body 141. The cooling plate 140 may have a length W2 longer than a length W1 of the battery cell 130. That is, the length W2 of the cooling plate 140 has a greater value than the length W1 of the battery cell 130, and both ends of the cooling plate 140 may each protrude outwardly relative to the battery cell 130. For example, the length of the cooling plate 140 protruding outwardly from each end portion relative to the battery cell 130 may be as much as half ((W2−W1)/2) of a difference between the length W2 of the cooling plate 140 and the length W1 of the battery cell 130.

In some embodiments, the cooling plate 140 and the cooling pipe 150 may have structural features as will be discussed below with reference to FIGS. 3 to 6.

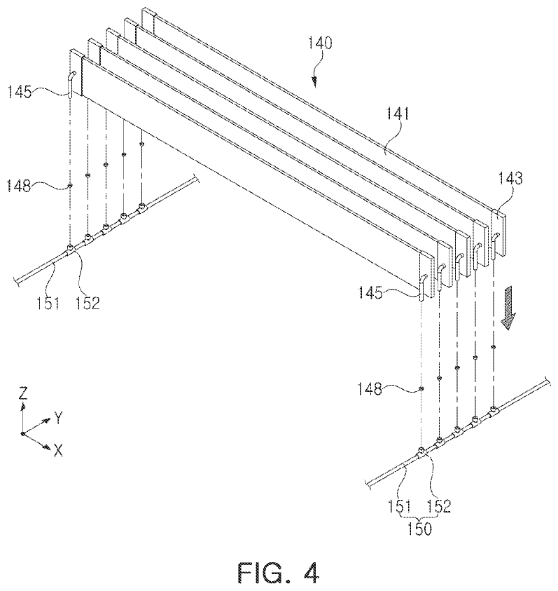

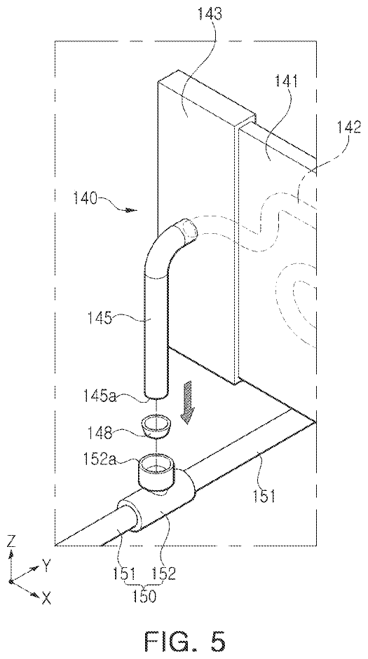

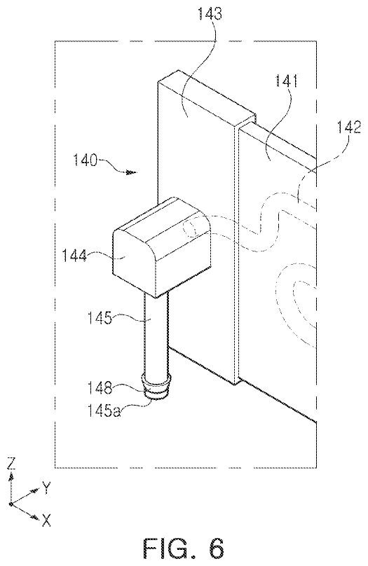

FIG. 3 is a perspective view illustrating a state in which the cooling plate 140 and the cooling pipe 150 illustrated in FIG. 1 are coupled, FIG. 4 is an exploded perspective view illustrating a state in which the cooling plate 140 and the cooling pipe 150 illustrated in FIG. 3 are separated, FIG. 5 is an exploded perspective view illustrating an enlarged cooling plate 140 and cooling pipe 150 illustrated in FIG. 4, and FIG. 6 is a perspective view illustrating a modified example of the cooling plate 140.

Referring to FIGS. 3 to 5, the cooling plate 140 may include the main body 141 having the cooling flow path 142 and the first connector 145. A connection body 143 for connecting the first connector 145 to the main body 141 may be provided between the first connector 145 and the main body 141. The connection body 143 may be integrally formed with the first connector 145 or may be integrally formed with the main body 141. The first connector 145 may be integrally formed with the connection body 143 or attached to the connection body 143. However, the first connector 145 may be directly coupled to the main body 141 without the connection body 143 therebetween. The first connector 145 may extend in the same third direction Z as the direction (e.g., −Z axis direction) in which the cooling plate 140 is accommodated in the accommodation space (S in FIG. 1).

The cooling pipe 150 may include a main pipe 151 through which a refrigerant flows and a second connector 152 branching from the main pipe 151. The second connector 152 may extend in a direction opposite to the first connector 145. The second connector 152 may include a T-shaped elbow connected to the main pipe 151, but the disclosed technology is not limited thereto. The main pipe 151 may connect the second connectors 152 adjacent to each other.

The first connector 145 may include a first open end portion 145a in which a portion opposite to the second connector 152 is open, and the second connector 152 may include a second open end portion 152a facing the first connector 145 to correspond to the first open end portion 145a of the first connector 145. The first open end portion 145a and the second open end portion 152a may be disposed to face each other.

The first connector 145 may have a shape in which the first open end portion 145a extends in the second direction Y downwardly and is then bent downwardly in the third direction Z. The first connector 145 may have a shape bent in an L shape as a whole. In this case, since the first connector 145 is disposed in a region corresponding to a large surface of the cooling plate 140, a wasted space for coupling the first connector 145 may be reduced. That is, since the first connector 145 does not protrude in the first direction X, which is a horizontal direction, a dead space of the housing 110 in the first direction X may be reduced.

In a state in which the cooling pipe 150 is disposed in a lower portion of the accommodation space S, each cooling plate 140 may move in the third direction Z to be coupled to the second connector 152 of the cooling pipe 15. Since the first connector 145 and the second connector 152 are disposed to face each other in the third direction Z, the first connector 145 may move in the third direction (Z is the arrow direction in FIGS. 4 and 5) to be coupled to the second connector 152. Therefore, since the direction (e.g., −Z axis direction) in which the cooling plate 140 is disposed in the accommodation space S of the housing 110 and the direction (e.g., −Z axis direction) for a flow path between the cooling plate 140 and the cooling pipe 150 are the same, the cooling plate 140 and the cooling pipe 150 may be easily connected, while the cooling plate 140 is disposed in the accommodation space S of the housing 110.

At least some of the plurality of cooling plates 140 may simultaneously move in the third direction Z to be coupled to the cooling pipe 150. That is, at least some of the plurality of first connectors 145 and a plurality of second connectors 152 corresponding thereto may be coupled together. In addition, it is also possible to simultaneously move all of the plurality of cooling plates 140 in the third direction Z and couple the same to the cooling pipe 150. Although the battery cell 130 is not illustrated in FIGS. 3 and 4 for clarity of illustration, the plurality of cooling plate 140 and the cooling pipe 150 may be connected in a state in which the plurality of cooling plates 140 and the plurality of battery cells 130 are stacked. However, the disclosed technology is not limited to the example where the plurality of cooling plates 140 is assembled at once, and it is also possible to move the cooling plates 140 in the third direction Z and couple the cooling plates 140 to the cooling pipes 150, respectively.

A sealing member 148 may be disposed between an outer circumferential surface of the first connector 145 and an inner circumferential surface of the second connector 152 to provide watertightness between the cooling plate 140 and the cooling pipe 150.

In some implementations, as illustrated in FIG. 6, the cooling plate 140 may include a connection connector 144 for connection to the connection body 143. In this case, the first connector 145 may extend in the second direction Y through the connection connector 144 and may then extend downwardly in the third direction Z. That is, the first connector 145 may be bent in an L shape through the connection connector 144. Since the cooling plate 140 illustrated in FIG. 6 has a structure that is similar or identical to or corresponding to the cooling plate 140 illustrated in FIGS. 3 to 5 except for the connection connector 144, a detailed description thereof will be omitted.

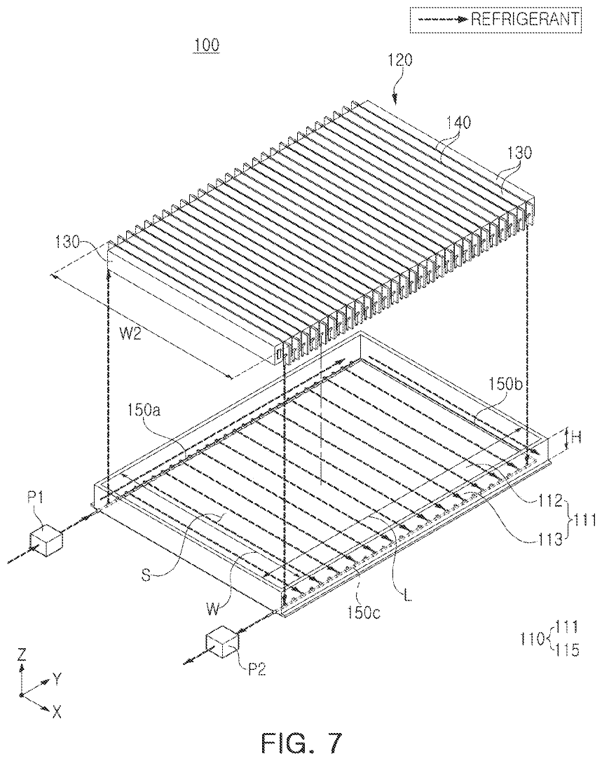

In some embodiments, a refrigerant in the battery device 100 based on an example embodiment may flow as will be discussed below with reference to FIG. 7 together with FIGS. 1 to 3,

FIG. 7 is a diagram illustrating flow of a refrigerant in the battery device 100 illustrated in FIG. 1.

The cooling pipe 150 may include an inlet flow path 150a for supplying a refrigerant to the cooling plate 140 and an outlet flow path 150c through which a refrigerant discharged from the cooling plate 140 flows. The inlet flow path 150a and the outlet flow path 150c may be disposed to be adjacent to a corner between the sidewall 113 and the bottom plate 112 of the housing 110, and thus, a wasted spaces for installing the cooling pipe 150 may be reduced.

The second connector 152 of the inlet flow path 150a may be connected to the first connector 145 installed on one side of the cooling plate 140, and the second connector 152 of the outlet flow path 150c may be connected to the first connector 145 installed on the other side of the cooling plate 140. Accordingly, the refrigerant introduced into the inlet flow path 150a may branch through the plurality of second connectors 152 to be supplied to the cooling flow paths respectively provided in the plurality of cooling plates 140 through the plurality of first connectors 145. In addition, the refrigerant flowing through the cooling flow paths 142 of the plurality of cooling plates 140 may be discharged to the outlet flow path 150c through the first connector 145. The refrigerants discharged from the cooling flow paths 142 of the plurality of cooling plates 140 may join in the outlet flow paths 150c through the plurality of second connectors 152. Accordingly, the plurality of cooling plates 140 arranged between the inlet flow path 150a and the outlet flow path 150c may form a plurality of branch flow paths in the first direction X.

In some implementations, the cooling pipe 150 may further include a connection flow path 150b disposed to be adjacent to the corner between the sidewall 113 and the bottom plate 112 of the housing 110 to connect the inlet flow path 150a and the outlet flow path 150c. In this case, the cooling pipe 150 may form a flow path through which the refrigerant sequentially flows through the inlet flow path 150a, the connection flow path 150b, and the outlet flow path 150c. When the connection flow path 150b is provided, the refrigerant flowing through the inlet flow path 150a may be uniformly distributed and supplied to the cooling plate 140 located on an upstream side of the inlet flow path 150a and the cooling plate 140 located on a downstream side of the inlet flow path 150a. That is, since the cooling plate 140 located on the downstream side of the inlet flow path 150a is disposed to be adjacent to the connection flow path 150b and the refrigerant also flows through the connection flow path 150b, the refrigerant may be smoothly supplied to the cooling plate 140 located on the downstream side of the inlet flow path 150a.

In the cooling pipe 150, at least one pump P1 or P2 may be disposed upstream of the inlet flow path 150a or downstream of the outlet flow path 150c to supply a refrigerant. For example, a pressure pump P1 may be installed upstream of the inlet flow path 150a or a suction pump P2 may be installed downstream of the outlet flow path 150c. The pressure pump P1 may press and supply a refrigerant to the inlet flow path 150a, and the suction pump P2 may provide suction force to suck the refrigerant from the outlet flow path 150c.

Since an assembly direction (e.g., −Z axis direction) for disposing the cooling plate 140 in the accommodation space S and a direction (e.g., −Z axis direction) in which the cooling plate 140 and the inlet flow path 150a and the outlet flow path 150c of the cooling pipe 150 are the same, the cooling plate 140 may be disposed so that a total length W2 substantially corresponds to a total width W of the accommodation space S. In addition, a length and height of the cell assembly 120 may be set to correspond to a total length L and a total height H of the accommodation space S. Accordingly, energy density of the battery device 100 may be increased by reducing loss of the accommodation space S.

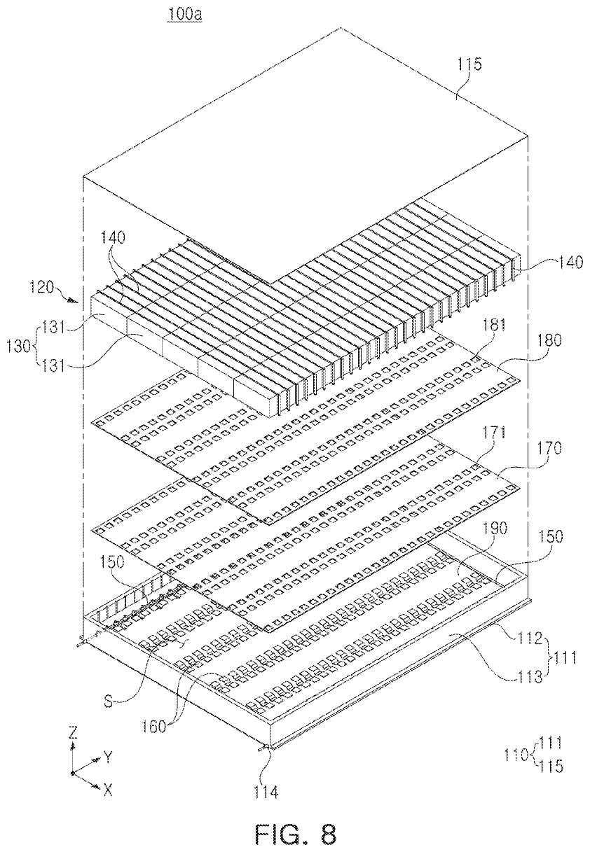

Next, a battery device 100a based on another example embodiment will be described with reference to FIGS. 8 to 12.

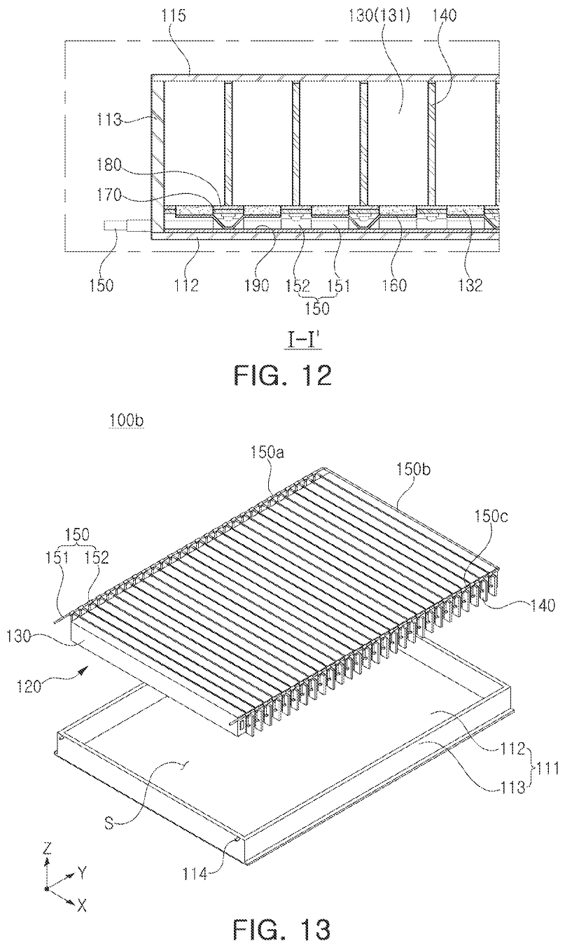

FIG. 8 is an exploded perspective view of the battery device 100a based on another example embodiment, FIG. 9 is a perspective view illustrating a state in which the cooling plate 140 and the battery cell 130 illustrated in FIG. 8 are installed, and FIG. 10 is an enlarged perspective view of one corner of the first housing 111 illustrated in FIG. 8, FIG. 11 is an exploded perspective view of some components of the battery device 100a illustrated in FIG. 8 viewed from a lower direction, and FIG. 12 is a cross-sectional view taken along line I-I′ of FIG. 10.

The battery device 100a illustrated in FIGS. 8 to 12 may include the housing 110, a plurality of battery cells 130, a plurality of cooling plates 140, and the cooling pipe 150, like the battery device 100 described above with reference to FIGS. 1 to 7. The battery device 100a may include a busbar 160 disposed below the plurality of battery cells 130 and further include at least some of an insulating plate 170, a support plate 180, and an additional plate 190.

Referring to FIG. 8, the battery device 100a based on another example embodiment may include the housing 110, a plurality of battery cells 130, a plurality of cooling plates 140, the cooling pipe 150, and the busbar 160.

Since the housing 110, the plurality of battery cells 130, the plurality of cooling plates 140, and the cooling pipes 150 correspond to or are similar to those of the battery device 100 described above with reference to FIGS. 1 to 7, the components identical to or corresponding to those of the battery device 100 described above with reference to FIGS. 1 to 7 are given the same reference numerals. In order to avoid unnecessary duplication, among the components of the battery device 100a illustrated in FIGS. 8 to 12, components identical to or corresponding to those of the battery device 100 described above with reference to FIGS. 1 to 7 will only be briefly described and a description thereof will be replaced with the description given above with reference to FIGS. 1 to 7. However, among the housing 110, the plurality of battery cells 130, the plurality of cooling plates 140, and the cooling pipe 150, components having differences will be mainly described.

The accommodation space S is formed inside the housing 110. The housing 110 may include a first housing 111 and a second housing 115. The first housing 111 may have a shape in which the accommodation space S is formed, and the second housing 115 may have a structure covering the accommodation space S. The first housing 111 may include the bottom plate 112 and the sidewall 113. The plurality of battery cells 130, the plurality of cooling plates 140, and the cooling pipe 150 may be accommodated in the accommodation space S formed in the housing 110. In addition, at least some of the busbar 160, the insulating plate 170, the support plate 180, and the additional plate 190 may be additionally disposed in the accommodation space S.

The plurality of battery cells 130 may be accommodated in the accommodation space S. The plurality of battery cells 130 may be arranged in the accommodation space S in a state of being erected in the third direction Z. The plurality of battery cells 130 may be stacked in the second direction Y, and the cooling plate 140 may be disposed between at least some of the battery cells 130. The battery cell 130 may include a plurality of cells 131 arranged in the first direction X.

The plurality of cooling plates 140 may be disposed in the accommodation space S in a state of being erected in the third direction Z. The cooling plate 140 may be disposed between at least some of the plurality of battery cells 130. The battery cells 130 may be disposed on both sides of the cooling plate 140, respectively. The cooling plates 140 and the battery cells 130 may be alternately stacked with each other.

The plurality of battery cells 130 and the plurality of cooling plates 140 may be stacked in the second direction Y to form the cell assembly 120. To form the cell assembly 120, the plurality of battery cells 130 and the plurality of cooling plates 140 may be fixed to each other.

The cooling pipe 150 may be connected to the cooling plate 140 so that a refrigerant flows. The cooling pipe 150 may supply a refrigerant to the cooling flow path (e.g., 142 of FIG. 10) of the cooling plate 140 or may be a passage through which the refrigerant discharged from the cooling flow path (e.g., 142 of FIG. 10) flows.

The cooling pipe 150 may be disposed in the housing 110 so as to be located in a lower portion of the accommodation space S of the housing 110. In order to reduce the space occupied by the cooling pipe 150, the cooling pipe 150 may be disposed to be adjacent to a corner at which the bottom plate 112 and the sidewall 113 meet. The cooling pipe 150 may be disposed along the corner at which the bottom plate 112 and the sidewall 113 meet. An opening 114 for a pipe may be formed in the housing 110 so that the cooling pipe 150 is exposed to the outside of the housing 110.

The busbar 160 electrically connects an electrode terminal (133 in FIG. 9) of an adjacent battery cell 130 or electrically connects an electrode terminal 133 of an adjacent cell 131. The busbar 160 may be disposed to be adjacent to the bottom plate 112 in the accommodation space S of the housing 110. The busbar 160 may be electrically connected to the electrode terminal 133 of the battery cell 130 to realize serial and/or parallel electrical connection between the battery cells 130.

The busbar 160 may be disposed to face upwardly in the third direction Z so that the busbar 160 may contact the electrode terminal (e.g., 133 in FIG. 9) when the battery cell 130 is disposed in the accommodation space S in the third direction Z.

An insulating plate 170 including an insulating material may be disposed between the plurality of battery cells 130 and the busbar 160. The insulating plate 170 may include a through-hole 171 through which the electrode terminal 133 passes. The insulating plate 170 may provide electrical insulation between a body portion of the battery cell 130 and the busbar 160 excluding the electrode terminal 133. The insulating plate 170 may be formed of an electrical insulating material, such as plastic.

A support plate 180 supporting the plurality of battery cells 130 may be disposed between the insulating plate 170 and the plurality of battery cells 130. The support plate 180 may include a through-hole 181 through which the electrode terminal 133 passes. The support plate 180 may divide the accommodation space S into a space in which the cell assembly 120 is disposed and a space in which the busbar 160 is disposed. The support plate 180 may have rigidity capable of supporting the plurality of battery cells 130 and the plurality of cooling plates 140. The support plate 180 may include a metal material, but is not limited thereto and may include a material for providing rigidity capable of supporting the cell assembly 120.

When the support plate 180 is installed, the insulating plate 170 may electrically insulate the support plate 180 and the busbar 160 from each other.

An additional plate 190 may be disposed between the busbar 160 and the bottom plate 112. The additional plate 190 may include an insulating material. The additional plate 190 may electrically insulate the busbar 160 and the bottom plate 112 from each other.

FIG. 9 illustrates a portion of the cell assembly 120, illustrating a state in which the battery cells 130 are installed on both sides of the cooling plate 140, respectively.

Referring to FIG. 9, the battery cell 130 may include a plurality of cells 131 disposed in the first direction X. FIGS. 8 and 9 illustrate a configuration in which the battery cell 130 includes five cells 131, but the number of cells 131 constituting the battery cell 130 may be variously changed to, for example, one or two or more. The plurality of cells 131 in each battery cell 130 may be connected in series.

Each cell 131 may include a secondary battery in which an electrode assembly (not shown) is accommodated in the casing 132. Each cell 131 may include a prismatic secondary battery, but is not limited thereto and may also include a pouch-type secondary battery.

Each battery cell 130 may include a plurality of electrode terminals 133. The electrode terminal 133 of the battery cell 130 may be disposed on a lower side of the casing 132 in the third direction Z. The electrode terminal 133 may include two terminals having different polarities (e.g., a positive terminal and a negative terminal), and the two terminals may be disposed on the lower side of the casing 132.

The battery cells 130 may be disposed on both sides of the cooling plate 140, respectively. When the cooling plates 140 and the battery cells 130 are alternately stacked, the cooling plates 140 may be disposed on both sides of the battery cells 130, respectively. Accordingly, heat generated by the battery cell 130 may be discharged to the cooling plate 140 through both sides of the battery cell 130, thereby increasing cooling efficiency of the battery cell 130.

The cooling flow path 142 may be formed inside the cooling plate 140 to allow a refrigerant to flow therethrough. The cooling plate 140 may include the main body 141 facing the battery cell 130, and the cooling flow path 142 may pass through the main body 141. The main body 141 may have an area that may sufficiently contact a large surface (e.g., a surface on the X-Z plane) of the battery cell 130.

The cooling plate 140 may include the first connector 145 to supply a refrigerant to the cooling flow path 142 and discharge the refrigerant from the cooling flow path 142. The first connector 145 may include the first open end portion 145a opened downwardly in the third direction Z to be connected to the cooling pipe 150.

The refrigerant introduced through the first connector 145 on one side may flow through the cooling flow path 142 and then be discharged through the first connector 145 on the other side. The first connectors 145 may be respectively installed at both ends of the main body 141. The cooling plate 140 may have a state in which the first connectors 145 are exposed to the outside of the battery cell 130 at both ends of the main body 141. The first connectors 145 may extend straight from both ends of the main body 141 in the third direction Z.

Referring to FIG. 10, the housing 110 may include a support opening 113an into which the first connector 145 is inserted and supported. The support opening 113a may be formed in the sidewall 113. Since the support opening 113a is formed in the sidewall 113, a separate structure for supporting the first connector 145 may not be installed.

Since the first connector 145 has extends straight in the third direction Z, the support opening 113a corresponding thereto may also extend in the third direction Z.

The support opening 113a may have a diameter D1 through which the first connector 145 and the first open end portion 145a may pass when the cooling plate 140 is disposed in the accommodation space S in the third direction Z. The support opening 113a may have a diameter greater than that of the first connector 145 so that the first connector 145 may be easily inserted thereinto.

The support opening 113a may have a groove shape extending in the third direction Z and open in the first direction X. That is, the support opening 113a may have a groove shape in which a portion of the first connector 145 is exposed externally. Alternatively, the support opening 113a may have a hole shape (closed cross-sectional shape) extending in the third direction Z. The support opening 113a may have a cross-sectional shape corresponding to that of the first connector 145. The first connector 145 may have a shape including a circular cross-section or an arcuate cross-section, and the support opening 113a may also have a shape including a circular cross-section or an arcuate cross-section correspondingly. However, the cross-sectional shapes of the first connector 145 and the support opening 113a are not limited to the aforementioned cross-sectional shapes and may have a square shape.

The support opening 113a may have a shape that prevents the first connector 145 from being separated from the support opening 113an in a direction, perpendicular to the third direction Z. For example, the support opening 113a may prevent the first connector 145 from moving in a horizontal direction and being separated from the support opening 113a.

When the support opening 113a has a groove shape extending in the third direction Z, a diameter D2 of the open portion may have a value smaller than the diameter D1 to prevent separation of the first connector 145.

The cooling pipe 150 may include the main pipe 151 through which a refrigerant flows and the second connector 152 branching from the main pipe 151. The main pipe 151 may connect the second connectors 152 adjacent to each other. The second connector 152 may extend in a direction opposite to the first connector 145. The second connector 152 may include a second open end portion 152a facing the first connector 145 to correspond to the first open end portion 145a of the first connector 145. The first open end portion 145a and the second open end portion 152a may be disposed to face each other.

The cooling pipe 150 may be disposed in the lower portion of the accommodation space S to be adjacent to the bottom plate 112. Since the first connector 145 of the cooling plate 140 is inserted into and supported in the support opening 113a formed in the sidewall 113, the cooling pipe 150 coupled to the first connector 145 may be disposed in an installation space S1 of the support opening 113a. The sidewall 113 may have a step shape to have the installation space S1 in which the cooling pipe 150 is disposed. The sidewall 113 may be integrally formed, but alternatively, the sidewall 113 may be manufactured in a split type and then integrated by a known coupling method, such as welding or bolting.

Since the first connector 145 has a shape extending in the third direction Z and moves in the third direction Z to be coupled to the second connector 152, loss of space for coupling the first connector 145 may be reduced. That is, since the first connector 145 does not protrude in the first direction X, which is a horizontal direction, a dead space of the housing 110 in the first direction X may be reduced.

Each cooling plate 140 may move in the third direction to be coupled to the second connector 152 of the cooling pipe 150 in a state in which each cooling pipe 150 is disposed in the lower portion of the accommodation space S. Since the first connector 145 and the second connector 152 are disposed to face each other in the third direction Z, the first connector 145 may move in the third direction (Z; a direction of the arrow in FIG. 10) to be coupled to the connector 152. Therefore, since the direction in which the cooling plate 140 is disposed in the accommodation space S of the housing 110 (e.g., −Z axis direction) and the direction (e.g., −Z axis direction) for the flow path connection between the cooling plate 140 and the cooling pipe 150 are the same, it is possible to easily connect the cooling plate 140 and the cooling pipe 150, while arranging the cooling plate 140 in the accommodation space S of the housing 110.

At least some of the plurality of cooling plates 140 may simultaneously move in the third direction Z to be coupled to the cooling pipe 150. That is, at least some of the plurality of first connectors 145 and the plurality of second connectors 152 corresponding thereto may be coupled to each other at once. In addition, it is also possible to simultaneously move all of the plurality of cooling plates 140 in the third direction Z and couple the same to the cooling pipe 150.

In some implementations, the busbar 160 may include a base 161 fixed to a lower portion of the accommodation space S and contact portions 162 extending from the base 161 to both sides.

Referring to FIGS. 11 and 12 together with FIG. 10, the electrode terminal 133 of the battery cell 130 may be disposed downwardly in the third direction Z to contact the busbar 160. Corresponding to the electrode terminal 133 of the battery cell 130, the busbar 160 may be disposed to face upwardly in the third direction Z. When the plurality of battery cells 130 are accommodated in the accommodation space S in the third direction Z, the electrode terminals 133 of the plurality of battery cells 130 may be electrically connected to the busbar 160. Therefore, in an example embodiment, the electrical connection of the electrode terminal 133 of the battery cell 130 may be easily performed.

The contact portion 162 may be elastically deformed so that electrical connection between the electrode terminal 133 and the busbar 160 may be ensured. For elastic deformation of the contact portion 162, the contact portion 162 may have a shape extending upwardly from the base 161 in the third direction Z. However, the shape or arrangement of the busbar 160 may be changed variously.

A plurality of cells 131 in each battery cell 130 may be connected in series by a busbar 160. To this end, in the busbar 160 electrically connecting the electrode terminals 133 of the plurality of cells 131 in one battery cell 130, the contact portions 162 may be disposed on both sides of the base 161 in the first direction X.

Also, adjacent battery cells 130 may be connected in series and/or parallel by the busbar 160. In the busbar 160 connecting the electrode terminals 133 of adjacent battery cells 130 in series, the contact portions 162 may be disposed on both sides of the base 161 in the second direction Y.

The support plate 180 may be disposed between the insulating plate 170 and the plurality of battery cells 130 to support the plurality of battery cells 130. The support plate 180 may include the through-hole 181 through which the electrode terminal 133 passes. The support plate 180 may divide the accommodation space S into an upper space in which the cell assembly 120 is disposed and a lower space in which the busbar 160 and the cooling pipe 150 are disposed. That is, the support plate 180 may divide the accommodation space S into a two-layer structure.

The through-hole 171 through which the busbar 160 passes may be formed in the insulating plate 170 so that the electrode terminal 133 of the battery cell 130 may contact the busbar 160. When the support plate 180 is installed, the insulating plate 170 may electrically insulate the support plate 180 and the busbar 160 from each other.

The additional plate 190 may be disposed between the busbar 160 and the bottom plate 112, and the busbar 160 may be disposed on the additional plate 190. The additional plate 190 may include an insulating material and may electrically insulate the busbar 160 and the bottom plate 112 from each other.

Finally, a battery device 100b based on another example embodiment will be described with reference to FIGS. 13 to 15.

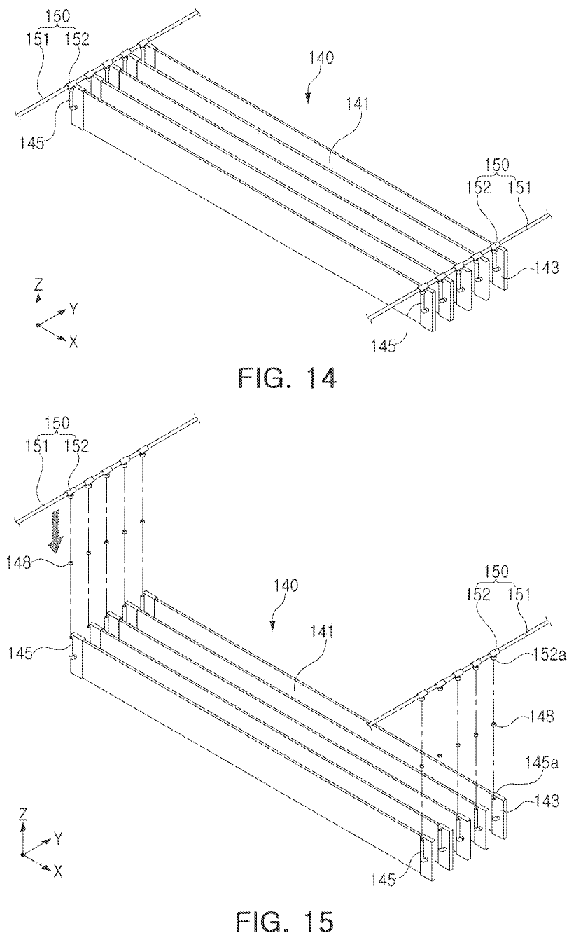

FIG. 13 is an exploded perspective view of the battery device 100b based on another example embodiment, and FIG. 14 is a perspective view illustrating a state in which the cooling plate 140 and the cooling pipe 150 illustrated in FIG. 13 are coupled to each other, and FIG. 15 is an exploded perspective view illustrating a state in which the cooling plate 140 and the cooling pipe 150 illustrated in FIG. 13 are separated from each other.

Like the battery device 100 described above with reference to FIGS. 1 to 7, the battery device 100b illustrated in FIGS. 13 to 15 may include the housing 110, a plurality of battery cells 130, a plurality of cooling plates 140, and the cooling pipe 150. The battery device 100b illustrated in FIGS. 13 to 15 has the same configuration as the configuration of the battery device 100 described above with reference to FIGS. 1 to 7, except that the cooling pipe 150 is disposed above the cooling plate 140. Therefore, the same reference numerals are given to components that correspond to each other. In order to avoid redundancy, detailed descriptions of components identical to or corresponding to those of the battery device 100 described above with reference to FIGS. 1 to 7, among the components of the battery device 100b illustrated in FIGS. 13 to 15, are omitted and will be replaced with the descriptions given above with reference to FIGS. 1 to 7.

In the battery device 100b illustrated in FIGS. 13 to 15, the cooling pipe 150 is disposed above the cooling plate 140. The cell assembly 120 may include a plurality of battery cells 130 and a plurality of cooling plates 140, and in a state in which the cell assembly 120 is accommodated in the accommodation space S of the housing 110, the cooling pipe 150 may move downwardly (e.g., the direction of the arrow in FIG. 15) in the third direction Z so that the second connector 152 may be connected to the first connector 145 of the cooling plate 140.

Even in the case of the battery device 100b illustrated in FIGS. 13 to 15, the direction (e.g. −Z axis direction) in which the cooling plate 140 is disposed in the accommodation space S of the housing 110 and the direction of the flow path connection between the cooling plate 140 and the cooling pipe 150 are the same, the cooling plate 140 and the cooling pipe 150 may be easily connected to each other.

In some implementations, in the battery device 100b illustrated in FIGS. 13 to 15, the electrode terminal (133 in FIG. 9) of the battery cell 130 may be disposed to face downwardly in the third direction and the busbar (160 in FIG. 10) may be disposed in the accommodation space S to face upwardly in the third direction Z, like the battery device 100a described above with reference to FIGS. 8 to 12. In this case, when the plurality of battery cells 130 are accommodated in the accommodation space S in the third direction Z, the electrode terminals (133 in FIG. 9) of the plurality of battery cells 130 may be electrically connected to the busbar (160 in FIG. 10). Therefore, in an example embodiment, the electrical connection of the electrode terminal of the battery cell 130 may be easily performed.

In an example embodiment in the present disclosure, it is possible to effectively implement the flow path connection of the cooling plate. In particular, in an example embodiment, since the direction in which the cooling plate is disposed in the housing is the same as the direction of the flow path connection between the cooling plate and the cooling pipe, the cooling plate and the cooling pipe may be easily connected to each other, while the cooling plate is disposed in the accommodation space of the housing.

In addition, in an example embodiment, the flow path connection between the cooling plate and the cooling pipe may have a simple structure.

In addition, in an example embodiment, the flow path of the cooling plate can be effectively connected, and the electrical connection of the electrode terminals of the battery cell may be facilitated.

In addition, in an example embodiment, cooling efficiency may be improved.

Also, in an example embodiment, the energy density of the battery device may be improved by reducing the space for installing the cooling pipe.

The disclosed technology can be implemented in various electrochemical devices such as rechargeable secondary batteries that are widely used in battery-powered devices or systems, including, e.g., digital cameras, mobile phones, notebook computers, hybrid vehicles, electric vehicles, uninterruptible power supplies, battery storage power stations, and others including battery power storage for solar panels, wind power generators and other green tech power generators. Specifically, the disclosed technology can be implemented in some embodiments to provide improved electrochemical devices such as a battery used in various power sources and power supplies, thereby mitigating climate changes in connection with uses of power sources and power supplies. Lithium secondary batteries based on the disclosed technology can be used to address various adverse effects such as air pollution and greenhouse emissions by powering electric vehicles (EVs) as alternatives to vehicles using fossil fuel-based engines and by providing battery-based energy storage systems (ESSs) to store renewable energy such as solar power and wind power.

Only specific examples of implementations of certain embodiments are described. Variations, improvements and enhancements of the disclosed embodiments and other embodiments may be made based on the disclosure of this patent document.

What is claimed is:

1. A battery device comprising:
a housing structured to provide an accommodation space;
a plurality of battery cells accommodated in the accommodation space;
a plurality of cooling plates, each cooling plate disposed between adjacent battery cells of the plurality of battery cells and including a cooling flow path to transfer heat out of the adjacent battery cells;
a cooling pipe connected to the cooling plate to allow a refrigerant to flow through the cooling flow path; and
a busbar electrically connected to the plurality of battery cells and disposed to be adjacent to a bottom plate of the housing in the accommodation space,
wherein the plurality of battery cells and the plurality of cooling plates extend in a first direction and are stacked in a second direction, crossing the first direction,
the cooling pipe is coupled to the cooling plate in a third direction, crossing the first and second directions, and
the plurality of battery cells includes an electrode terminal disposed to face toward the busbar in the third direction to be in contact with the busbar.

2. The battery device of claim 1, wherein at least one of the plurality of cooling plates extends in the third direction to be coupled to the cooling pipe.

3. The battery device of claim 1, wherein
the cooling plate includes a first connector extending in the third direction,
the cooling pipe includes a second connector in contact with a main pipe and extending in a direction that is opposite to the first connector, and
the first connector is configured to be coupled to the second connector.

4. The battery device of claim 3, wherein
the cooling plate further includes a main body facing the battery cell, the cooling flow path being formed in the main body, and
the first connector is installed at both ends of the main body.

5. The battery device of claim 4, wherein the cooling plate has a length longer than a length of the battery cell, wherein the first connector is configured to be exposed to an outside of the battery cell at both ends of the main body.

6. The battery device of claim 4, wherein the first connector has a shape extending from both ends of the main body in the third direction.

7. The battery device of claim 4, wherein the housing includes a support opening into which the first connector is inserted and supported.

8. The battery device of claim 7, wherein the support opening has a shape extending in the third direction structured to prevent the first connector from being separated from the support opening in a direction that is perpendicular to the third direction.

9. The battery device of claim 7, wherein the cooling pipe is disposed in a lower portion of the support opening in the accommodation space.

10. The battery device of claim 4, wherein the first connector includes a portion that extends in the second direction and another portion that is bent in the third direction.

11. The battery device of claim 1, further comprising:
an insulating plate including an insulating material and disposed between the plurality of battery cells and the busbar,
wherein the insulating plate includes a through-hole through which the electrode terminal passes.

12. The battery device of claim 11, further comprising:
a support plate structured to support the plurality of battery cells and disposed between the insulating plate and the plurality of battery cells,
wherein the support plate includes a through-hole through which the electrode terminal passes.

13. The battery device of claim 11, further comprising an additional plate including an insulating material and disposed between the busbar and the bottom plate.

14. The battery device of claim 1, wherein
the cooling pipe includes an inlet flow path structured to supply the refrigerant to the cooling plate and an outlet flow path through which the refrigerant discharged from the cooling plate flows, and
the inlet flow path and the outlet flow path are disposed to be adjacent to a corner between a sidewall and the bottom plate of the housing.

15. The battery device of claim 14, wherein the cooling pipe further includes a connection flow path disposed to be adjacent to the corner between the sidewall and the bottom plate of the housing to connect the inlet flow path to the outlet flow path.

16. The battery device of claim 1, wherein
the battery cell includes a plurality of cells arranged in the first direction, and
each cell includes a prismatic secondary battery or a pouch-type secondary battery.

17. The battery device of claim 16, wherein the battery cell has a structure in which the plurality of cells are connected in series.

18. A battery device comprising:
a housing including an accommodation space;
a cell assembly including a plurality of battery cells accommodated in the accommodation space and a plurality of cooling plates, each cooling plate disposed between adjacent battery cells of the plurality of battery cells and including a cooling flow path;
a cooling pipe connected to the cooling plate to allow a refrigerant to flow through the cooling flow path; and
a busbar electrically connected to the plurality of battery cells and disposed to be adjacent to a bottom plate of the housing in the accommodation space,
wherein the cell assembly is accommodated in the accommodation space in a third direction in a state in which the cooling pipe and the busbar are disposed inside the accommodation space,
the plurality of battery cells includes electrode terminals disposed to face toward the busbar in the third direction to be in contact with the busbar, and
the plurality of cooling plates and the cooling pipe are coupled to each other, and the electrode terminals of the plurality of battery cells are electrically connected to the busbar.
